(19) United States
(12) Patent Application Publication
(10) Pub. No.: US 2015/0254145 A1
(43) Pub. Date: Sep. 10, 2015

(54) OPERATING SYSTEM/HYPERVISOR EFFICIENCIES FOR SUB-DIVIDED PRIVILEGE LEVELS

(71) Applicant: Microsoft Corporation, Redmond, WA (US)

(72) Inventors: Andreas Juergen Lachenmann, Munich (DE); John Joseph Richardson, Copville, WA (US); Holger Christoph Kenn, Garching (DE)

(73) Assignee: Microsoft Corporation, Redmond, WA (US)

(21) Appl. No.: 14/201,442

(22) Filed: Mar. 7, 2014

(51) Int. Cl. G06F 11/14; G06F 12/10; G06F 9/455

(52) U.S. Cl. CPC G06F 11/1484; G06F 9/45533; G06F 12/1027; G06F 2212/651

(57) ABSTRACT

Operating system/hypervisor efficiencies for sub-divided privilege levels is described, for example, where a plurality of execution processes at the same privilege level share at least part of a memory address translation structure. In various embodiments a first component of an original hierarchical memory address translation structure is duplicated and edited to omit entries not visible to both a trusted process and an untrusted process. In various examples, the duplicated component is used by an untrusted process together with other components of the original translation structure; the original translation structure is used by a trusted process. In various examples, additional copies of the first component are used for additional untrusted processes. In some examples, synchronization of the first component and its duplicate(s) is carried out on update of the translation structure. In some examples, synchronization of the first component and its duplicate(s) is carried out by a page fault handler.

### BACKGROUND

A privilege level, also referred to as a protection level, is a computer system hardware mechanism for controlling which instructions or which data access may be executed and which may not be executed. This enables different software applications to be separated from each other at the hardware level so that computer systems can have multiple users connected to them and/or run multiple application programs at the same time without problems. Otherwise one application may overwrite data of another application; or a malicious application may access private data of another application.

Privilege levels may be arranged in a hierarchy. For example, many computer systems have three privilege levels, the most privileged one used for a hypervisor called hypervisor level, a less privileged one used for an operating system kernel called OS level and a least privileged one used for executing user programs called user level. If a lower level privilege level generates an exception i.e. when it prevents code from being executed, the exception may be passed to the next highest privilege level in the hierarchy which takes appropriate action. For example, to deliver an error code to an application program from which code was prevented from executing; or to terminate the application program.

For given computer hardware, the number of privilege levels is fixed in the hardware depending on how the hardware was manufactured. Specific privilege levels are typically used by software in a fixed way so that, for example, operating system code cannot run at a user privilege level without modification of the operating system code.

It is often desired to sub-divide a privilege level into a plurality of processes which may execute at that privilege level. For example, to sub-divide a user privilege level in order that protection between more user applications is possible. There is an ongoing need to improve the mechanisms for sub-dividing privilege levels of computing devices. With the increase in use of resource-constrained devices such as smart phones, there is ongoing need for efficiency of operation and also for reduction of memory requirements.

The embodiments described below are not limited to implementations which solve any or all of the disadvantages of existing computing devices with sub-divided privilege levels.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Operating system/hypervisor efficiencies for sub-divided privilege levels is described, for example, where a plurality of execution processes at the same privilege level share at least part of a memory address translation structure. In various embodiments a first component of an original hierarchical memory address translation structure is duplicated and edited to omit entries not visible to both a trusted process and an untrusted process. In various examples, the duplicated component is used by an untrusted process together with other components of the original translation structure; the original translation structure is used by a trusted process. In various examples, additional copies of the first component are used for additional untrusted processes. In some examples, synchronization of the first component and its duplicate(s) is carried out on update of the translation structure. In some examples, synchronization of the first component and its duplicate(s) is carried out by a page fault handler.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a plurality of computing devices having sub-divided privilege levels;

FIG. 2 is a schematic diagram of a memory management and process control component of a computing device without sharing of a memory address translation structure;

FIG. 3 is a schematic diagram of a memory management and process control component of a computing device with sharing of a memory address translation structure;

FIG. 4 is a flow diagram of a method at a trusted process executed by an operating system or hypervisor;

FIG. 5 is a flow diagram of a method at a scheduler of an operating system or hypervisor;

FIG. 6 is a flow diagram of a method at a page fault handler of an operating system or hypervisor;

FIG. 7 is a flow diagram of a method of synchronization carried out by an operating system or hypervisor;

FIG. 8 illustrates an exemplary computing-based device in which embodiments of an operating system and/or hypervisor may be implemented.

The same reference numerals are used to designate similar parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

In various examples described in this document, the memory of untrusted code is shared with trusted code. In addition to using separate processes for trusted and untrusted code various of the examples describe sub-division of privilege levels i.e. that the trusted code has control over the untrusted code. In some examples, the trusted code may access the untrusted code's memory but not vice-versa.

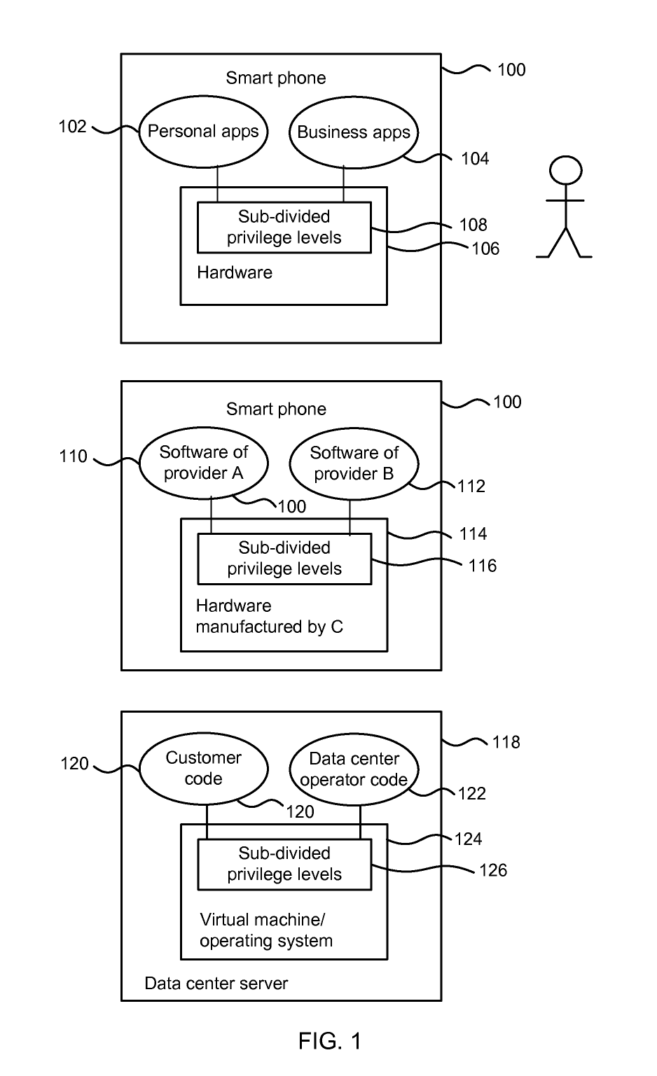

FIG. 1 is a schematic diagram of two smart phones 100 and a data center computing entity 118. Each of these computing entities uses sub-divided privilege levels 108, 116, 126 as described herein to enable two or more software applications to execute at the same computing entity without interference. For example, a smart phone 100 has both personal software applications 102 and business software applications 104. By using sub-divided privilege levels 108 hardware 106 of the smart phone may be controlled to prevent access to data of the business applications by the personal applications and vice versa. In this way a user of the smart phone 100 may operate both his work and home email applications for example, on the same smart phone. Both the end user and the user's employer have reassurance that the home email data and the business email data stored at the smart phone are protected from one another.

Another example concerns a smart phone having hardware 114 manufactured by manufacturer C, an operating system comprising software of provider A 110, and an email application comprising software of provider B 112. By using sub-divided privilege levels 116 the hardware 114 is controlled so that the operating system and the software of provider B 112 may execute whilst protecting data of each entity (A, B, C) from each of the other entities.

Another example concerns a data center server 118 or other computing entity from a data center. Sub-divided privilege levels 126 are used by a virtual machine or operating system 124 at the data center server. The sub-divided privilege levels enable customer code 120 and data center operator code 122 to execute with protection from one another. This is especially useful where the customer code uses private data such as customer details, payment details and other secure data which needs to be kept protected from the data center operator code.

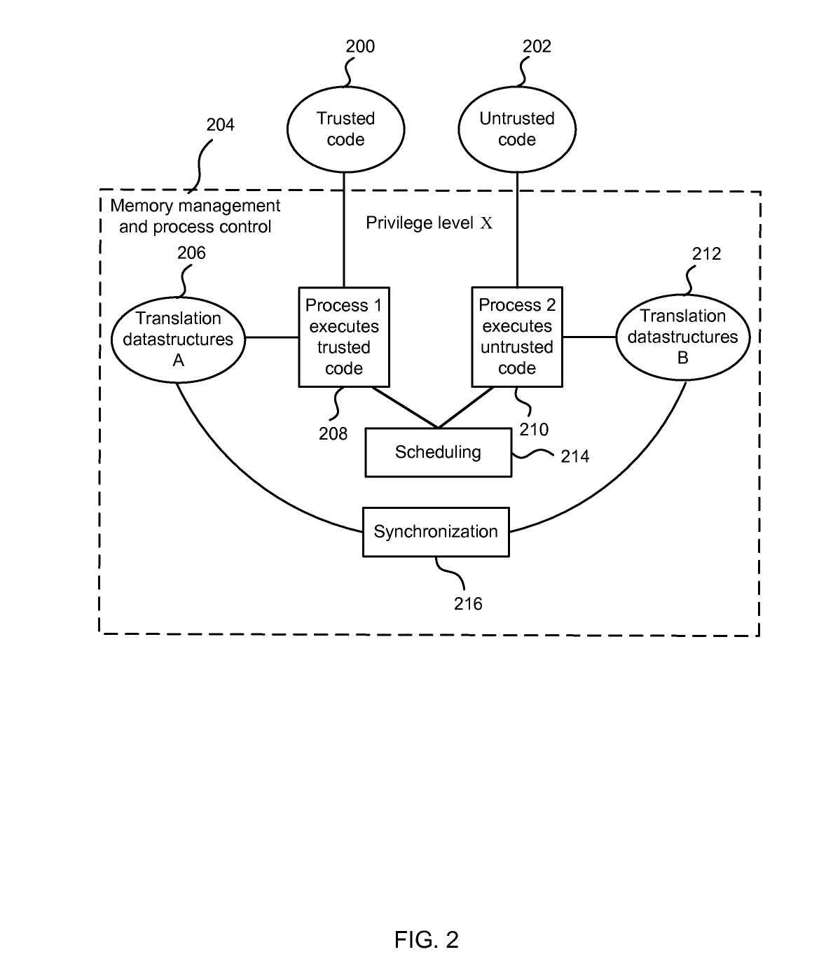

FIG. 2 is a schematic diagram of a memory management and process control component 204 of a computing device without sharing of a memory address translation structure. The memory management and process control component may comprise an operating system and/or hypervisor. In this example, the memory management and process control component 204 uses hardware features to create processes. In the example of FIG. 2 two processes are illustrated, process 1, 208 executing trusted code 200 and process 2, 210 executing untrusted code 202. The arrangement of FIG. 2 may be extended to have more processes although only two are illustrated for clarity. The two processes 208 and 210 are within a same privilege level of the memory management and process control component 204. That is, the memory management and process control component 204 uses hardware features at the computing device to subdivide an operating system or a hypervisor privilege level into two or more processes at the same privilege level. This enables process 1, executing trusted code, to be protected from process 2 which executes untrusted code.

In the example of FIG. 2 the subdivision is achieved by creating two translation data structures, one for each of the two processes. Process 1 uses translation data structures A 206 and process 2 uses translation data structures B 212. If more processes are formed, each additional process has its own translation data structures created.

A translation data structure is any store which holds a mapping for translating virtual addresses that are used by software to physical addresses that are used to address hardware facilities such as memory devices. A translation data structure may be hierarchical in some examples. For example, it may comprise a cascade of sub-translation data structures. In some examples, the translation data structure comprises a page tree.

In the example of FIG. 2, process 1 and process 2 may appear, from the point of view of an operating system, to be operating at a user mode privilege level. To exchange data between process 1 and process 2 the translation data structures A 206 and B 212 may be configured in such a way that both processes have access to the same memory area. Otherwise process 1 is protected with respect to process 2 because process 2 is unable to access memory areas of process 1.

A scheduling process 214 within the memory management and process control component 204 controls which of process 1 and process 2 executes at any one time. That is, process 1 and process 2 do not execute in parallel but execute in an interleaved fashion as controlled by a scheduling process 214. However, where a multi-core machine is used, process 1 and process 2 may execute in parallel using the multiple cores. Updates to the translation data structures A occur during operating of the computing device. To take these updates into account, synchronization mechanisms 216 are used to update the translation data structures of each process.

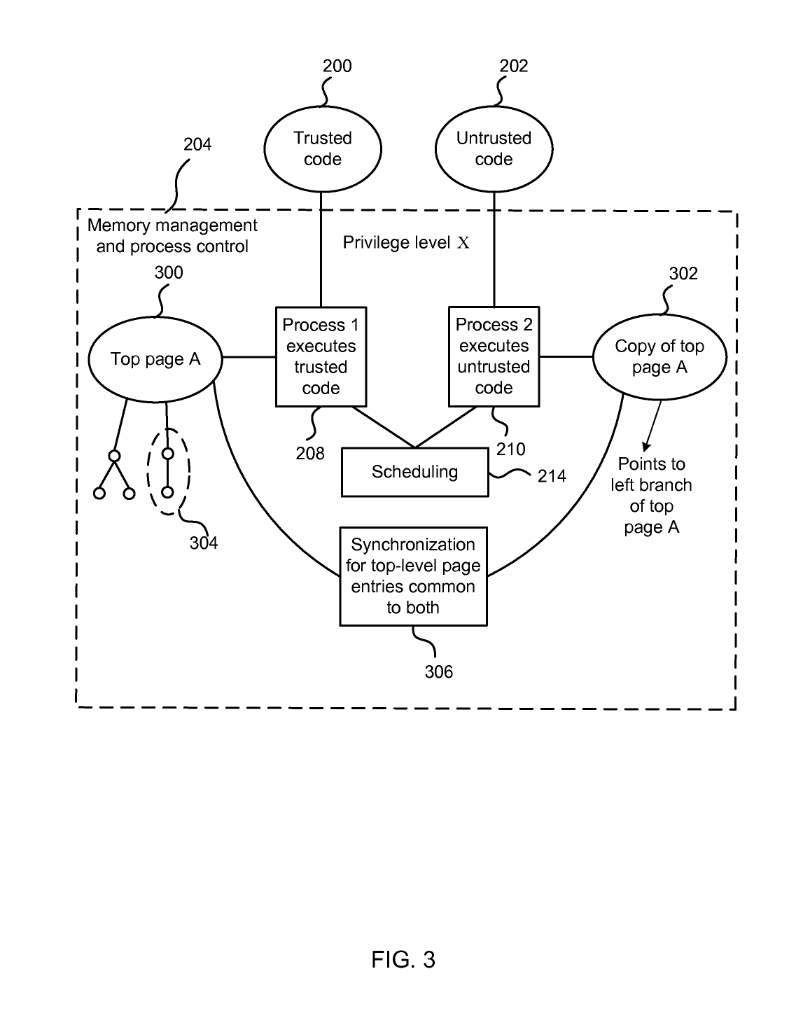

It is recognized herein that duplication of the translation data structures increases memory usage at the computing device. Also, synchronization mechanisms take up computing resources. The example of FIG. 3 illustrates how memory usage may be greatly reduced. It also illustrates how synchronization may be simplified. This is achieved without compromising protection between the processes. A simple, efficient and effective way of subdividing privilege levels which is applicable to a wide range of problems is given.

FIG. 3 shows the memory management and process control component 204 of FIG. 2 where the translation data structures B are modified, the synchronization mechanism is different and the scheduling may be achieved in a particularly efficient manner.

In this example process 1 208 which executes the trusted code, shares at least part of its translation data structure A with process 2, 210 executing untrusted code. By sharing at least part of the translation data structure of the trusted process, significant memory savings are gained. This is because full translation data structures are not stored separately for each process.

For example, trusted process 1, 208 has a translation data structure comprising a plurality of components. A first one of the components 300 is copied and the copy 302 is used by process 2, 210. The copy 302 of the first component comprises one or more pointers which refer back to one or more other components of the translation data structure of the trusted process.

In some examples the translation data structure of the trusted process is hierarchical. Using a hierarchical translation data structure enables particularly good memory efficiencies to be achieved.

For example, the first component 300 is a part of a hierarchy comprising a root level and zero or more subsequent levels of the hierarchy. In some examples, the translation data structure is a page tree and the first component 300 is a root of a page tree, referred to as a top-level page (as illustrated in FIG. 3) and the other components are lower level nodes or groups of nodes of a page tree. It is not essential to use a tree structure. Other types of hierarchical structure may be used including software defined hierarchies (e.g. mibs)

The copy 302 of the first component may be edited to remove translation information about memory areas that the untrusted process is not allowed access to. This editing process is done automatically by the memory management and process control component as described in more detail below. The trusted code 200 may comprise information about which memory locations are to be kept secret and not shared with untrusted processes. For example, in FIG. 3 branch 304 of a page tree of trusted process 1, 208, is not to be visible to process 2. The copy of top page A is edited so that it only points to the left branch of process 1's page tree. In this case, starting from the copy of top page A 302 a process is unable to access memory locations identified by branch 304.

A scheduling mechanism 214 is very efficiently able to switch between process 1 and process 2 because this now involves switching between a first component of translation data structure A and a copy of that first component. This switch may be achieved by updating a single control register in some examples

A synchronization mechanism 306 is greatly simplified. This is because only the first component and the copy of the first component are to be synchronized. Also, only entries which appear in both (or are common to both) the first component and the copy of the first component are to be synchronized.

The functionality of the memory management and process control component described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs).

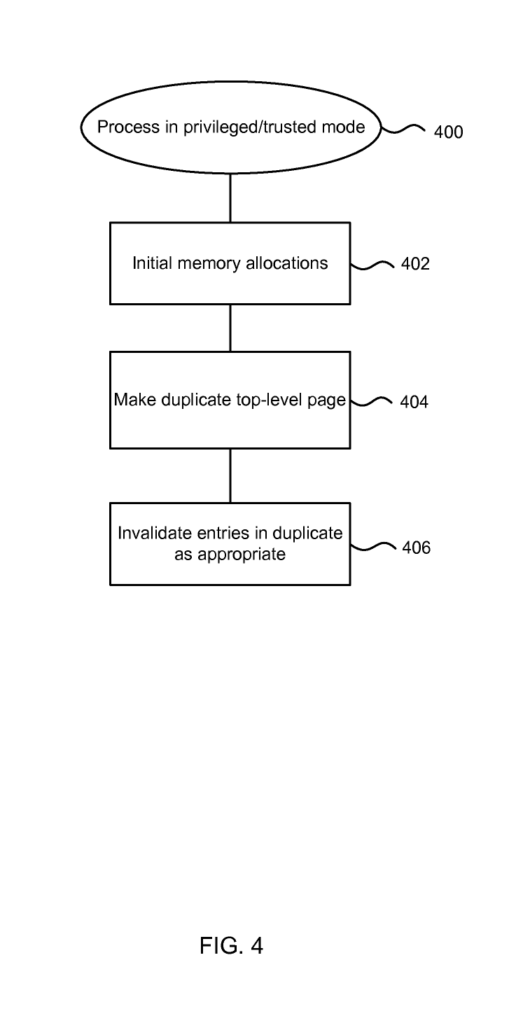

FIG. 4 is a flow diagram of a method at a trusted process executed by an operating system or hypervisor. For example, a method at process 1, 208 of FIG. 3. The process is executing 400 the trusted code in privileged/trusted mode. It has already made initial memory allocations 402 for executing the trusted process. During these initial memory allocations 402 a translation data structure is created for the trusted process on the basis of the initial memory allocations. The trusted process detects that untrusted code is also to be executed. It makes a duplicate of a first component of the translation data structure. For example, it makes a duplicate of a top-level page of a page tree of the trusted process. This duplicate of the top-level page still refers to the same rest of the page table (except for entries that become invalid as now described). The trusted process takes knowledge from the trusted code and uses that to invalidate 406 one or more entries in the duplicate of the first component. The invalidated entries are those identifying memory which is to be secure to the trusted code. The trusted code triggers the operating system or hypervisor to create a second process for the untrusted code and assigns the duplicate of the first component to that second process. By duplicating only the top-level page in this way, almost no additional memory is required.

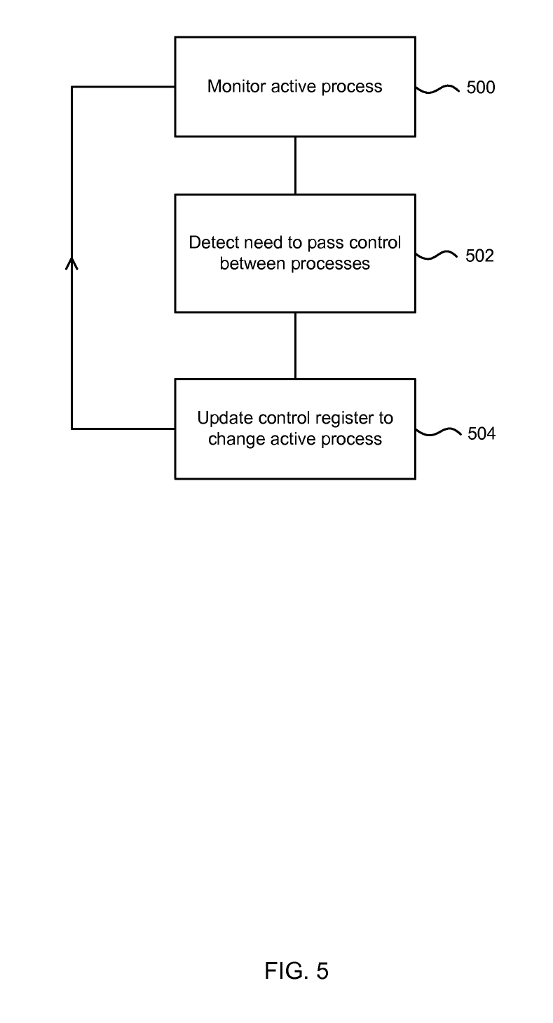

FIG. 5 is a flow diagram of a method at a scheduler of an operating system or hypervisor. The scheduler, or scheduling mechanism, monitors 500 a currently active process at the computing device. For example, this may be process 1 or process 2 in the example of FIG. 3. The scheduler detects 502 a need to pass control between the processes. This detection is achieved in any suitable manner. For example a policy may be enforced by the trusted code and when the policy is not going to be met the trusted code signals to the scheduler a need to pass control.

To pass control between the processes the scheduling mechanism may update 504 a control register to switch between the top-level page and the copy of the top-level page as appropriate.

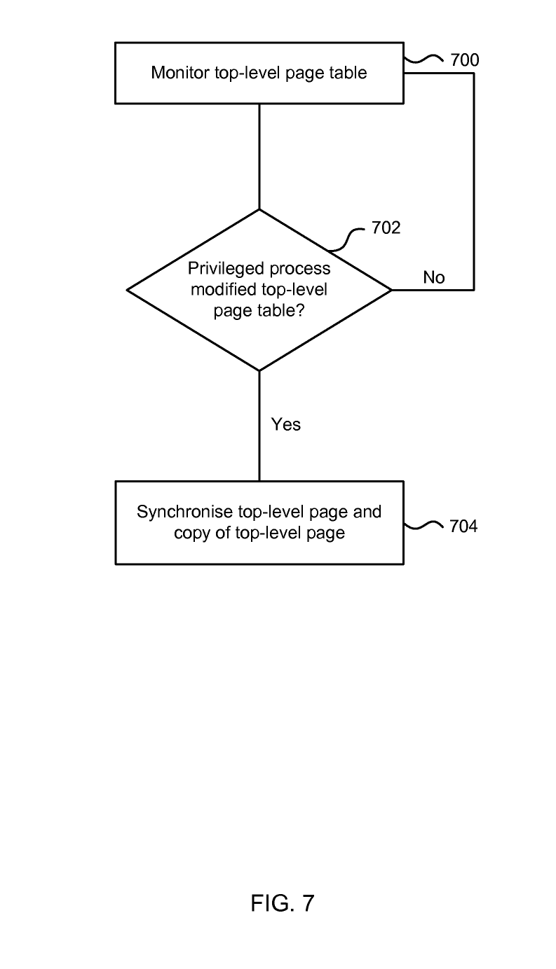

In another example, the scheduling mechanism calls an operating system API to schedule the execution of untrusted code in the unprivileged process and then waits. The scheduler then schedules the unprivileged process to execute the unprivileged code. When the execution of unprivileged code ends the scheduler passes back control to the privileged process to continue executing trusted code. Synchronization processes may occur at this point as described with reference to FIG. 7.

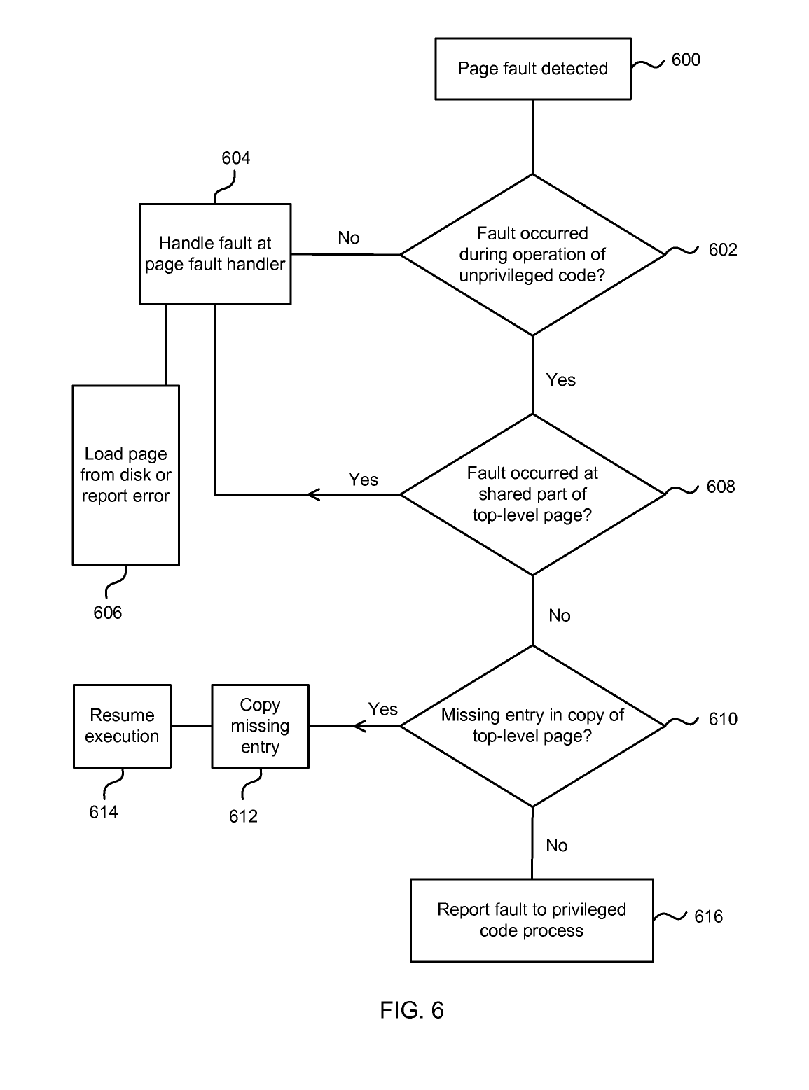

FIG. 6 is a flow diagram of a method at a page fault handler of an operating system or hypervisor. A page fault is an error that occurs when an entry looked up in the translation data structure is not found. This might be because the stored data has been moved to disk or because of a synchronization error in situations where duplicates of the translation data structure have not been properly updated. The method of FIG. 6 may be used instead of, or as well as, the synchronization method of FIG. 7 depending on the application domain. For example, where updates to the translation data structure are relatively infrequent the method of FIG. 6 may be used. There is a trade-off here between the cost of synchronization and the expected number of page faults due to synchronization errors. The method FIG. 6 works for paging in memory pages. It does not work in the code path when the part of the page table that the top-level entry refers to is paged out to disk, moved, or deallocated. In that case, the method of FIG. 7 may be used to keep the page tables immediately synchronized, otherwise the process might access some random pages.

When the memory management and process control component detects a page fault 600 it makes a check 602 as to whether the fault occurred during operation of unprivileged code. If not a standard page fault handler is used to handle the fault 604 by loading a page from disk or reporting an error 606. If the page fault occurred during operation of unprivileged code a check 608 is made as to whether the fault occurred at a shared part of the first component (e.g. top-level page) of the translation data structure. If so, the standard page fault handler process 604 takes over. If not, a check 610 is made as to whether the missing entry (that gave rise to the page fault) is supposed to be in the copy of the first component (e.g. copy of the top-level page). If so, synchronization takes place. This involves copying 612 the missing entry from the translation data structure of the trusted process to the copy of the first component. Execution is then resumed 614. If the missing entry is not supposed to be in the copy of the first component then a fault is reported 616 to the privileged code process.

FIG. 7 is a flow diagram of a method of synchronization carried out by an operating system or hypervisor. The synchronization mechanism of the operating system or hypervisor monitors 700 a first component of the translation data structure of a trusted process. For example, it monitors a top-level page of a page tree. The synchronization mechanism checks 702 if the privileged process modifies the top-level page. If not it continues to monitor. If there is modification then synchronization between the first component and the copy of the first component is carried out. For example, between the top-level page and a copy of the top-level page.

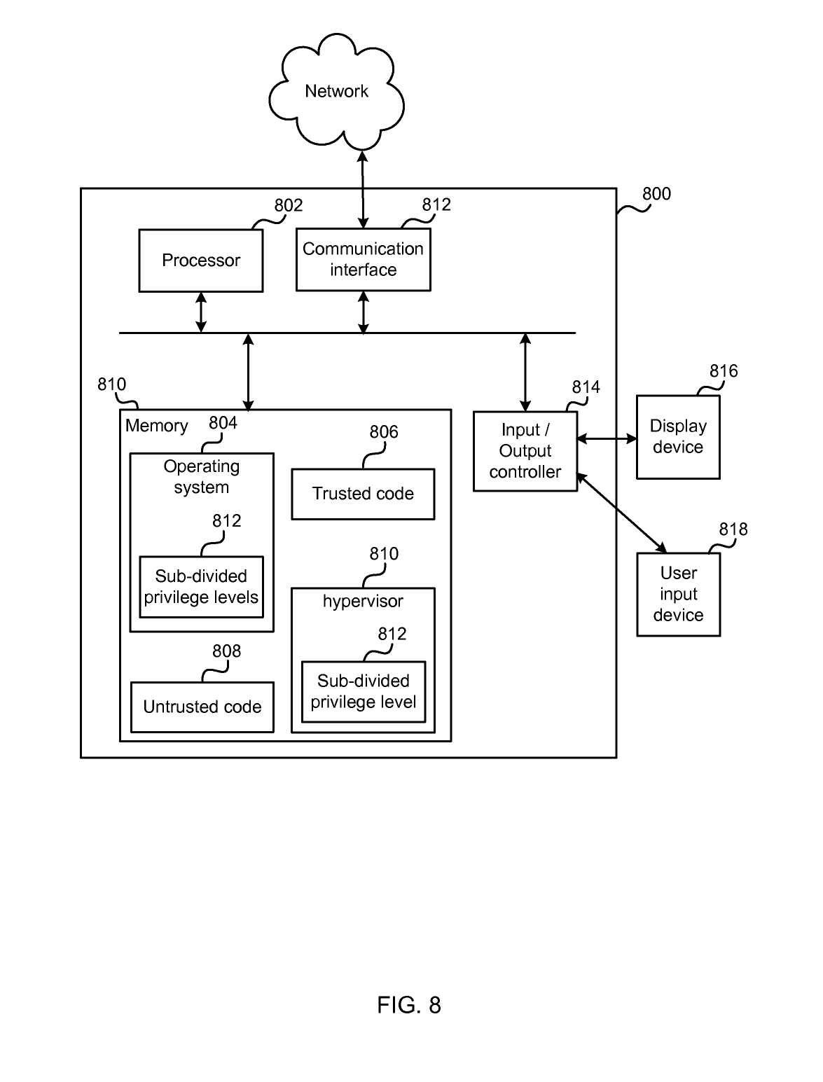

FIG. 8 illustrates various components of an exemplary computing-based device 800 which may be implemented as any form of a computing and/or electronic device, and in which embodiments of sub-divided privilege levels which share at least part of a memory address translation data structure may be implemented.

Computing-based device 800 comprises one or more processors 802 which may be microprocessors, controllers or any other suitable type of processors for processing computer executable instructions to control the operation of the device in order to protect a trusted process from one or more untrusted processes in situations where the processes share at least part of a memory address translation data structure. In some examples, for example where a system on a chip architecture is used, the processors 902 may include one or more fixed function blocks (also referred to as accelerators) which implement a part of the method of protecting processes in hardware (rather than software or firmware). Platform software comprising an operating system 804 or any other suitable platform software may be provided at the computing-based device to enable application software comprising both trusted code 806 and untrusted code 808 to be executed on the device. The operating system may have sub-divided privilege levels 812. In some examples, a hypervisor 810 at the computing based device 800 has sub-divided privilege levels 812 formed and used as described herein.

The computer executable instructions may be provided using any computer-readable media that is accessible by computing based device 800. Computer-readable media may include, for example, computer storage media such as memory 810 and communications media. Computer storage media, such as memory 810, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 810) is shown within the computing-based device 800 it will be appreciated that the storage may be distributed or located remotely and accessed via a network or other communication link (e.g. using communication interface 812). Communication interface 812 enables the computing-based device 800 to communicate with other computing entities.

The computing-based device 800 also comprises an input/output controller 814 which may output display information to a display device 816 which may be separate from or integral to the computing-based device 800. The display information may provide a graphical user interface, for example, to enable a human operator to use the untrusted code and/or trusted code. The input/output controller 814 may be arranged to receive and process input from one or more devices, such as a user input device 818 (e.g. a mouse, keyboard, camera, microphone or other sensor). In some examples the user input device 818 may detect voice input, user gestures or other user actions and may provide a natural user interface (NUI). This user input may be used to operate one or more software applications at the device. In an embodiment the display device 816 may also act as the user input device 818 if it is a touch sensitive display device. The input/output controller 814 may also output data to devices other than the display device, e.g. a locally connected printing device.

Any one or more of the input/output controller 814, display device 816 and the user input device 818 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computer-implemented method comprising:
using a memory management and process control component of a computing device to execute a trusted process in a protected manner with respect to at least one untrusted process executed at the same privilege level of the computing device;
creating a first translation data structure for translating between virtual memory addresses used by the trusted process and physical memory addresses of the computing device;
sharing at least part of the first translation data structure with the untrusted process.

2. The method of claim 1 carried out at either an operating system or a hypervisor.

3. The method of claim 1 wherein the first translation data structure is hierarchical.

4. The method of claim 1 wherein the first translation data structure is hierarchical and sharing at least part of the first translation data structure comprises sharing a root and zero or more subsequent levels of the first translation data structure.

5. The method of claim 1 wherein the first translation data structure is a page tree and sharing at least part of the first translation data structure comprises sharing at least a top-level page of the page tree.

6. The method of claim 1 comprising sharing at least part of the first translation data structure by copying the part to be shared and editing the copy to omit virtual and/or physical memory addresses protected from the untrusted process.

7. The method of claim 6 comprising synchronizing the at least part of the first translation data structure and the edited copy only with respect to memory addresses shared by the trusted and untrusted processes.

8. The method of claim 6 comprising carrying out the synchronization when the first translation data structure is updated by the trusted process.

9. The method of claim 6 comprising carrying out the synchronization as a result of detecting a page fault.

10. The method of claim 6 comprising carrying out the synchronization at a page fault handler.

11. The method of claim 1 comprising switching between execution of the trusted and untrusted processes by updating only one control register.

12. The method of claim 1 at least partially carried out using hardware logic.

13. A computer-implemented method comprising:
using a memory management and process control component of a computing device to execute a trusted process in a protected manner with respect to at least one untrusted process executed at the same privilege level of the computing device;
creating a first hierarchical translation data structure for translating between virtual memory addresses used by the trusted process and physical memory addresses of the computing device;
sharing at least part of the first hierarchical translation data structure with the untrusted process.

14. A memory management and process control component of a computing device arranged to execute a trusted process in a protected manner with respect to at least one untrusted process executed at the same privilege level of the computing device;
a memory storing a first translation data structure for translating between virtual memory addresses used by the trusted process and physical memory addresses of the computing device;
the memory management and process control component arranged to share at least part of the first translation data structure with the untrusted process.

15. The memory management and process control component of claim 14 wherein the memory stores a second translation data structure for translating between virtual memory addresses used by the untrusted process and physical memory addresses of the computing device, the second translation data structure comprising an edited copy of only part of the first translation data structure.

16. The memory management and process control component of claim 15 wherein the memory stores the second translation data structure so that it comprises one or more pointers to parts of the first translation data structure.

17. The memory management and process control component of claim 14 wherein the first translation data structure is hierarchical.

18. The memory management and process control component of claim 17 arranged to share at least part of the first translation data structure by sharing a root and zero or more subsequent levels of the first translation data structure.

19. The memory management and process control component of claim 14 wherein the first translation data structure is a page tree.

20. The memory management and process control component of claim 14 being at least partially implemented using hardware logic selected from any one or more of: a field-programmable gate array, a program-specific integrated circuit, a program-specific standard product, a system-on-a-chip, a complex programmable logic device.
